(19) United States
(12) Patent Application Publication
(10) Pub. No.: US 2026/0231004 A1
(43) Pub. Date: Aug. 6, 2026

(54) METHOD FOR PROVISIONING WALK-IN WI-FI DEVICES

(71) Applicant: Charter Communications Operating, LLC, St. Louis, MO (US)

(72) Inventors: Loay O. KREISHAN, Aurora, CO (US); Ahmed BENCHEIKH, Aurora, CO (US)

(21) Appl. No.: 19/046,456

(22) Filed: Feb. 5, 2025

(51) Int. Cl. H04W 48/16; H04W 12/0471; H04W 12/06; H04W 12/72

(52) U.S. Cl. CPC H04W 48/16; H04W 12/0471; H04W 12/06; H04W 12/72

(57) ABSTRACT

Various embodiments include a method for using Access Network Query Protocol (ANQP) messages to provision a mobile device to access a Wi-Fi network via an access point. The method may include broadcasting beacon frames advertising support for ANQP and a walk-in provisioning capability. The access point may receive an ANQP query from a mobile device requesting login information, and transmit an ANQP response including account creation and provisioning information with a public key and configuration instructions. The access point may receive a subsequent ANQP query containing encrypted credentials, and upon successful authentication of the credentials by the access point or a network backend service, request a public key from the mobile device. The access point may generate or receive from the network backend service an encrypted Wi-Fi profile, and transmit it to the mobile device in an ANQP response. Finally, a secure connection may be established with the mobile device.

### FIELD OF INVENTION

The present disclosure relates to wireless network provisioning, and more particularly to a method for securely provisioning walk-in Wi-Fi mobile devices using enhanced IEEE 802.11u protocols.

### BACKGROUND

Wi-Fi networks have become ubiquitous in both public and private spaces, providing convenient internet access for users with mobile devices. However, the process of connecting new devices to these networks, particularly in public venues or for first-time users, often presents challenges. Related methods of network provisioning typically require manual input of credentials, interaction with network administrators, or assistance from customer support staff.

The IEEE 802.11u protocol was developed to enhance the capabilities of Wi-Fi networks, particularly in public hotspot scenarios. This protocol introduced features such as the Generic Advertisement Service (GAS) and the Access Network Query Protocol (ANQP), which allow devices to query network information before associating with an access point. These mechanisms enable devices to discover network capabilities, authentication methods, and other relevant information without requiring a full network connection.

Building upon the IEEE 802.11u framework, the Wi-Fi Alliance introduced Hotspot 2.0, also known as Passpoint. This standard aims to simplify the process of connecting to Wi-Fi networks by automating the discovery, selection, and authentication processes. Hotspot 2.0 leverages protocols like ANQP to improve the user experience when connecting to compatible networks.

Despite these advancements, challenges remain in provisioning Wi-Fi devices efficiently and securely, particularly for walk-in users who have not previously connected to a particular Wi-Fi network. Many existing solutions still require some degree of user intervention or pre-configuration, which may be inconvenient and time-consuming. Additionally, the exchange of sensitive information during the provisioning process raises security concerns.

### SUMMARY

Various aspects include methods for using Access Network Query Protocol (ANQP) messages for provisioning a mobile device to access a Wi-Fi network via an access point. This summary provides an introduction to various aspects in a simplified form that are further described below in the detailed description. This summary is not intended to identify key or essential features of the claimed subject matter, nor is it intended to be used as an aid in determining the scope of the claims.

Some aspects include methods performed by the access point that include the access point broadcasting beacon frames advertising support for ANQP and a walk-in provisioning capability, receiving an ANQP query from a mobile device requesting network information for creating a new account and a previously created account with an operator of the network, such as a loyalty account with a hotel chain, transmitting an ANQP response that provides network information to the mobile device, receiving an ANQP query for provisioning information for a network supporting walk-in provisioning from the mobile device, transmitting an ANQP response to the mobile device that includes provisioning information in an ANQP packet including a public key and configuration instructions for the mobile device, receiving a second ANQP query from the mobile device that contains encrypted credentials responsive to the provisioning information, authenticating or receiving authentication from a network backend system, upon successful authentication transmitting an ANQP response requesting a public key from the mobile device, receiving a third ANQP query including the mobile device's public key, generating an encrypted Wi-Fi profile based on the mobile device's network configuration parameters using the mobile device's public key, and transmitting the encrypted Wi-Fi profile to the mobile device in an ANQP response to enable establishing a secure connection with the mobile device.

In some aspects, the beacon frames may further include vendor-specific elements (VSE) signaling support for the walk-in provisioning capability. In some aspects, the login information requested by the mobile device may include an International Mobile Subscriber Identity (IMSI) or a Network Access Identifier (NAI). In some aspects, the ANQP response containing information for creating an account and provisioning information may further include terms and conditions for user acknowledgment. In some aspects, the authenticating operation may use an Extensible Authentication Protocol (EAP) with IMSI for subscriber verification or Network Access Identifier NAI. Some aspects may further include encrypting all communications between the mobile device and the access point using Protected Management Frames (PMF) to secure the method for provisioning the mobile device.

Some aspects include methods performed by the mobile device for obtaining provisioning to a Wi-Fi network that include scanning for beacon frames broadcasted by an access point that advertise support for an ANQP and a walk-in provisioning capability, transmitting a first ANQP query to the access point requesting login information for the network, receiving a first ANQP response from the access point including provisioning information including a public key and configuration instructions, transmitting a second ANQP query to the access point containing encrypted credentials and information responsive to the provisioning information, receiving a second ANQP response from the access point requesting a public key of the mobile device, transmitting the mobile device's public key to the access point, receiving an encrypted Wi-Fi profile from the access point encrypted based on the mobile device's public key, decrypting and installing the encrypted Wi-Fi profile, and using the Wi-Fi profile to establish a secure connection with the access point.

In some aspects, the mobile device may display a graphical user interface (GUI) listing available networks supporting walk-in provisioning and allowing a user to select a network to join. In some aspects, the first ANQP query message may include a request for a public key to enable the mobile device to encrypt information sent to the network. In some aspects, the login information requested by the mobile device may include an International Mobile Subscriber Identity (IMSI) or a Network Access Identifier (NAI). In some aspects, the information for creating an account and provisioning information received in the second ANQP response may further include terms and conditions for user acknowledgment. In some aspects, the mobile device may encrypt the transmitted credentials using a public key received from the access point. Some aspects may further include securing all communication between the mobile device and the access point using Protected Management Frames (PMF) and encryption.

Further aspects may include an access point and/or a mobile device having a processing system configured with processor-executable instructions to perform operations corresponding to any of the methods summarized above. Further aspects may include a non-transitory processor-readable storage medium having stored thereon processor-executable instructions configured to cause a processing system to perform operations corresponding to any of the methods summarized above. Further aspects may include an access point and/or a mobile device having various means for performing functions corresponding to any of the method operations summarized above.

### BRIEF DESCRIPTION OF THE FIGURES

The accompanying drawings, which are incorporated herein and constitute part of this specification, illustrate exemplary embodiments of the claims, and, together with the general description given and the detailed description, serve to explain the features herein.

FIG. 1 is a message flow diagram illustrating messages for provisioning a mobile device to access a Wi-Fi network according to various aspects of the present disclosure.

FIG. 2 is a process flow diagram of an overall method for provisioning a mobile device to access a Wi-Fi network according to various embodiments.

FIG. 3A is a block diagram of a provisioning system focusing on the access point elements and functional modules for enabling walk-in provisioning of a Wi-Fi network according to various embodiments.

FIG. 3B is a block diagram of the provisioning system focusing on the mobile device elements and functional modules for enabling walk-in provisioning of a Wi-Fi network according to various embodiments.

FIG. 4 is a process flow diagram of a method for an access point provisioning a mobile device to access a Wi-Fi network according to various embodiments.

FIG. 5 is a process flow diagram of a method for a mobile device for provisioning the mobile device to access a Wi-Fi network according to various embodiments.

FIG. 6 is a perspective diagram of a mobile computing device suitable for implementing various embodiments.

FIG. 7 illustrates a block diagram of a mobile device suitable for implementing various embodiments.

FIG. 8 illustrates a server suitable for implementing various embodiments.

### DETAILED DESCRIPTION

Various embodiments will be described in detail with reference to the accompanying drawings. Wherever possible, the same reference numbers will be used throughout the drawings to refer to the same or like parts. References made to particular examples and implementations are for illustrative purposes and are not intended to limit the scope of the claims.

Various embodiments include methods and systems for securely provisioning walk-in Wi-Fi mobile devices using enhanced IEEE 802.11u protocols. Various embodiments leverage and extend the capabilities of the Generic Advertisement Service (GAS) and Access Network Query Protocol (ANQP) to enable unauthenticated and unassociated mobile devices to securely exchange provisioning information with access points in Wi-Fi networks in order to facilitate provisioning of walk-in mobile devices with reduced user inconvenience or the need for manual configuration. The Wi-Fi provisional methods of various embodiments are referred to herein as an “ANQP and walk-in provisioning process” that may be part of a “Live Kitting (LK) protocol.”

Various embodiments use ANQP query and response message packets to request and exchange public keys between a mobile device and an access point, and to exchange encrypted authenticating information and credentials and encrypted Wi-Fi provisioning information. By using Protected Management Frames (PMF) and public key encryption of network provisioning data, the various embodiments ensure a high level of security throughout the provisioning process. Various embodiments provide mobile devices with the ability to discover networks supporting the walk-in provisioning capability, securely exchange necessary information, and authenticate and associate with the network using the encrypted provisioning elements, all without requiring significant changes to the existing IEEE 802.11u protocol.

The terms “computing system” and “computing device” are used herein to refer to (but not limited to) any one or all of servers, workstations, desktop computers, laptop computers, and other similar computing systems that include memory for storing documents and neural network computational data, and a programmable processing system that may be configured to provide the functionality of various embodiments. The processing system may include neural network processors, such as graphical processing units, and neural network memory modules for running specialized LLM AI modules trained or fine-tuned according to various embodiments.

The term “processing system” is used herein to refer to one or more processors, including multi-core processors, graphics processing units (GPU), neural network processing units (NPU), microprocessor units (MPU), arithmetic logic units (ALU), memory systems, etc., that are organized and configured to perform computing functions of various embodiments as described herein.

The terms “neural network” and “neural network model” are used herein to refer to an interconnected group of processing nodes (or neuron models) that collectively operate as a software application or process that controls a function of a computing device and/or generates an overall inference result as output. Individual nodes in a neural network may attempt to emulate biological neurons by receiving input data, performing simple operations on the input data to generate output data, and passing the output data (also called “activation”) to the next node in the network. Each node may be associated with a weight value that defines or governs the relationship between input data and output data. A neural network may learn to perform new tasks over time by adjusting these weight values. In some embodiments, the overall structure of the neural network and/or the operations of the processing nodes do not change as the neural network learns a task. Rather, learning is accomplished during a “training” process in which the values of the weights in each layer are determined. As an example, the training process may include causing the neural network to process a task for which an expected/desired output is known, comparing the activations generated by the neural network to the expected/desired output, and determining the values of the weights in each layer based on the comparison results.

Some embodiments include authenticating the mobile device and/or the user seeking to access a secure network. In some embodiments, this authentication operation may be performed in the access point. In some embodiments, this authentication may be performed by a server or service that communicates with the access point. In such embodiments, the authentication capabilities may include a database of authenticated mobile devices and/or user identifiers (ID). Such an authentication and authenticated ID database service may be part of or located within the network backend system or communicate with the backend system via the Internet or other network, such as via a URL. For ease of reference, such an authentication service outside of the access point may be referred to herein as a “network backend service” to encompass the location of the service within or connected to the network backend system.

Related methods for provisioning walk-in Wi-Fi devices typically require manual input of credentials, interaction with network administrators, or assistance from customer support staff. These approaches may be time-consuming, inefficient, and inconvenient for users, particularly in public venues or for first-time users. While protocols like IEEE 802.11u and standards such as Hotspot 2.0 have improved network discovery and selection, they still fall short in providing a fully automated and secure provisioning process for unauthenticated devices. Therefore, there is an unmet need for a method that can securely provision walk-in Wi-Fi mobile devices using enhanced existing protocols, enabling seamless connectivity without user intervention while maintaining robust security standards.

Various embodiments provide methods for securely provisioning walk-in Wi-Fi mobile devices using IEEE 802.11u protocols by leveraging and extending the capabilities of the GAS and ANQP to enable unauthenticated and unassociated mobile devices to securely exchange provisioning information with Wi-Fi networks. By utilizing ANQP query and response message packets, various embodiments facilitate the request and exchange of public keys between mobile devices and access points, which are then used for exchanging encrypted provisioning information.

Various embodiments introduce novel approaches to automate the provisioning process, allowing devices to discover networks supporting the provisioning capability, securely exchange necessary information, and authenticate and associate with the network using encrypted provisioning elements. This approach may enable reliable connectivity without user inconvenience or the need for manual configuration.

In some embodiments, various embodiments may employ public key encryption and the use of Protected Management Frames (PMF) to provide a high level of security throughout the provisioning process. The system may allow for the exchange of network profiles, credentials, and authentication methods in a secure manner.

By enhancing existing protocols, various embodiment methods disclosed herein may address limitations in current Wi-Fi provisioning processes, which often require manual input of credentials, interaction with network administrators, or assistance from customer support staff. The various embodiment methods disclosed herein may provide a more efficient, automated, and secure way to provision walk-in Wi-Fi devices, particularly in public venues or for first-time users.

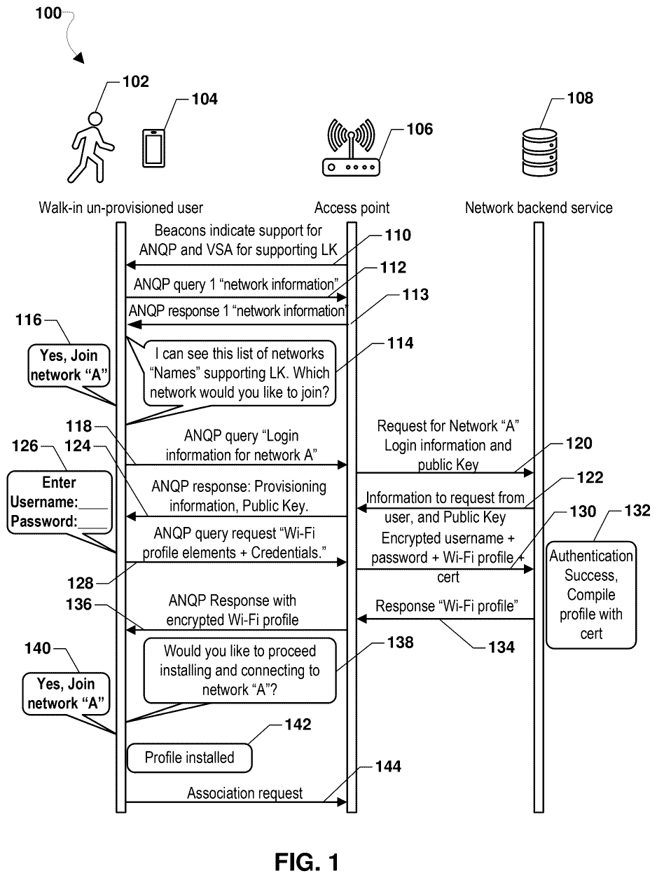

FIG. 1 illustrates a message flow diagram 100 depicting the sequence of communications between a user 102 with a mobile device 104, an access point 106, and network backend service 108 for provisioning the mobile device 104 to access a Wi-Fi network. The message flow diagram 100 shows the operations involved in the provisioning process for a walk-in un-provisioned user 102.

The process begins with a Wi-Fi advertisement broadcast 110 from the access point 106. In some embodiments, the access point 106 may broadcast beacon frames advertising support for the ANQP and a walk-in provisioning capability.

Upon detecting the Wi-Fi advertisement broadcast 110, the mobile device 104 may send an ANQP query message 112 to the access point 106. The ANQP query message 112 may request network information for the network, which the access point 106 may provide in an ANQP response message 113. The network information provided in the response message 113 may include a listing of networks that support walk-in provisioning.

Using this information, the mobile device 104 may present a user prompt 114 to the user 102, displaying a list of available networks supporting the walk-in provisioning capability. The user 102 may provide a user response 116, selecting a network to join.

Based on the user's selection, the mobile device 104 may send an ANQP query message 118 to the access point 106, requesting login information for the selected network and asking the access point to provide the network's public key to enable the mobile device to encrypt information sent to the network. The access point 106 may forward this request as a message 120 to the network backend service 108.

The network backend service 108 may respond with a message 122 containing information to request from the user 102 and the network's public key. The access point 106 may transmit this information to the mobile device 104 in the ANQP response message 124. This ANQP response message 124 may include provisioning information in an ANQP packet containing the public key and configuration instructions for the mobile device 104.

The mobile device 104 may present a user input prompt 126 to the user 102, requesting credentials or other necessary information. After collecting the required information, the mobile device 104 may send an ANQP query message 128 to the access point 106. The ANQP query message 128 may contain encrypted credentials responsive to the provisioning information.

An authentication process 132 may then be performed in which the access point 106 or the network backend service 108 authenticates the encrypted credentials provided by the mobile device 104. In implementations in which the network backend service 108 authenticates the mobile device and/or user, the access point 106 may forward the encrypted credentials as a message 130 to the network backend service 108. The user information (e.g., username and password), certifications, and other information that were encrypted by the mobile device 104 using the public key of the network backend service access point 106. The access point 106 may extract the encrypted information from the ANQP query message packets and forward the encrypted information without decryption, in which case the network backend service may decrypt the information and then perform the authentication operations.

Upon successful authentication, the network backend service 108 may generate a Wi-Fi profile message 134 and send it to the access point 106. The access point 106 may then transmit an ANQP response 136 to the mobile device 104, requesting a public key from the mobile device 104.

After receiving the public key from the mobile device 104, the access point 106 or the network backend service 108 may generate an encrypted Wi-Fi profile based on the mobile device's public key and network configuration parameters. The access point 106 may then transmit the encrypted Wi-Fi profile to the mobile device 104 in the ANQP response 136.

The mobile device 104 may present a user prompt 138 to the user 102, requesting permission to install the Wi-Fi profile. The user 102 may provide a user response 140 confirming the installation.

Following the user's confirmation (e.g., 140), a Wi-Fi profile installation process 142 may be performed on the mobile device 104. After successful installation of the Wi-Fi profile for the selected network, the mobile device 104 may send a Wi-Fi access request 144 to the access point 106, establishing a secure connection with the access point 106.

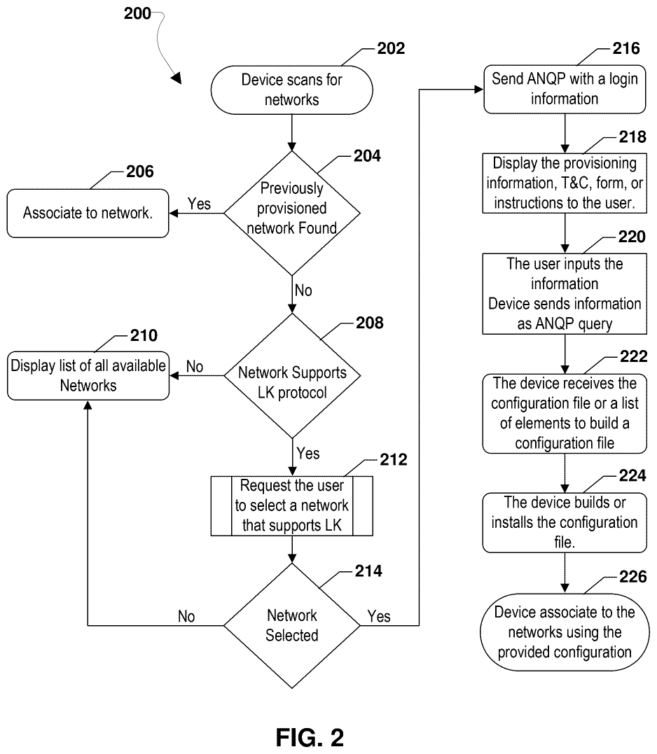

FIG. 2 is a flowchart of an overview of an embodiment method 200 for provisioning a mobile device to access a Wi-Fi network. The method 200 begins with a mobile device 104 scans for available networks in operation 202. In some embodiments, the mobile device 104 may scan for beacon frames broadcasted by an access point 106 that advertise support for the ANQP and walk-in provisioning capability. In some embodiments, if the access point 106 indicates that walk-in provisioning is supported, the mobile device 104 may send an ANQP query requesting network information, such as information regarding networks that support walk-in provisioning. In response, the access point 106 may send and the mobile device 104 may receive an ANQP response message including network information, such as a list of networks that support walk-in provisioning.

In a determination operation 204, the mobile device (e.g., 104) checks whether a previously provisioned network is found. If a previously provisioned network is found (i.e., determination operation 204=Yes), the mobile device 104 performing method 200 associates with the network in operation 206. If no previously provisioned network is found (i.e., determination operation 204=No), the mobile device 104 determines in operation 208 whether the network supports the walk-in provisioning “Live Kitting” (LK) protocol of various embodiments.

If the network does not support the walk-in provisioning Live Kitting protocol (i.e., determination operation 208=No), the mobile device 104 displays a list of all available networks in operation 210. If the network supports the walk-in provisioning Live Kitting protocol (i.e., determination operation 208=Yes), the mobile device 104 asks the user to select a network that supports walk-in provisioning Live Kitting protocol in operation 212. In some embodiments, the mobile device 104 may display a graphical user interface (GUI) listing available networks that advertise the walk-in provisioning capability and allow the user 102 to select a network to join.

In determination operation 214, the mobile device 104 checks whether a network is selected. If no network is selected, the mobile device returns to operation 210. If a network is selected (i.e., determination operation 214=Yes), the mobile device 104 transmits an ANQP query to the access point 106 requesting login information for the network in operation 216.

The mobile device 104 may display provisioning information and information for creating an account such as terms and conditions, forms, and/or instructions to the user 102 in operation 218. In some embodiments, the mobile device 104 may receive a first ANQP response from the access point 106 including provisioning information with configuration instructions. In some embodiments, the mobile device 104 may receive in the first ANQP response from the access point 106 a public key for use in encrypting completed forms and personal information specified in the information for creating an account.

In operation 220, the user 102 submits information (via the mobile device 104), and the mobile device 104 transmits a second ANQP query to the access point containing encrypted credentials and information responsive to the provisioning information. In some embodiments, the mobile device 104 may receive a second ANQP response from the access point 106 requesting a public key of the mobile device 104. The mobile device 104 may then transmit its public key to the access point 106.

In operation 222, the mobile device 104 receives a configuration file or list of elements to build a configuration file. In some embodiments, the mobile device 104 may receive an encrypted Wi-Fi profile from the access point 106, generated based on the public key and network configuration parameters.

In operation 224, the mobile device 104 builds or installs the configuration file. In some embodiments, the mobile device 104 may decrypt and install the encrypted Wi-Fi profile.

Finally, in operation 226, the mobile device 104 associates with the network using the provided configuration, establishing a secure connection with the access point 106.

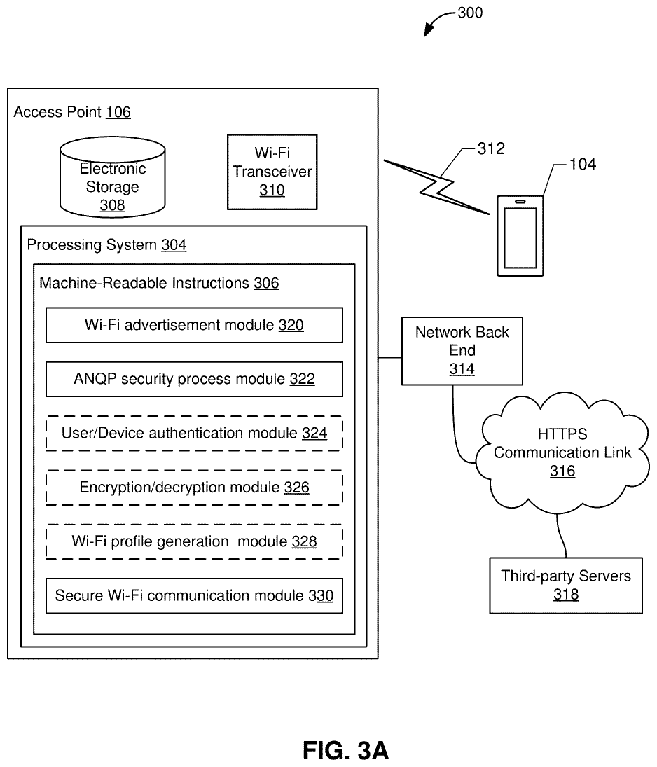

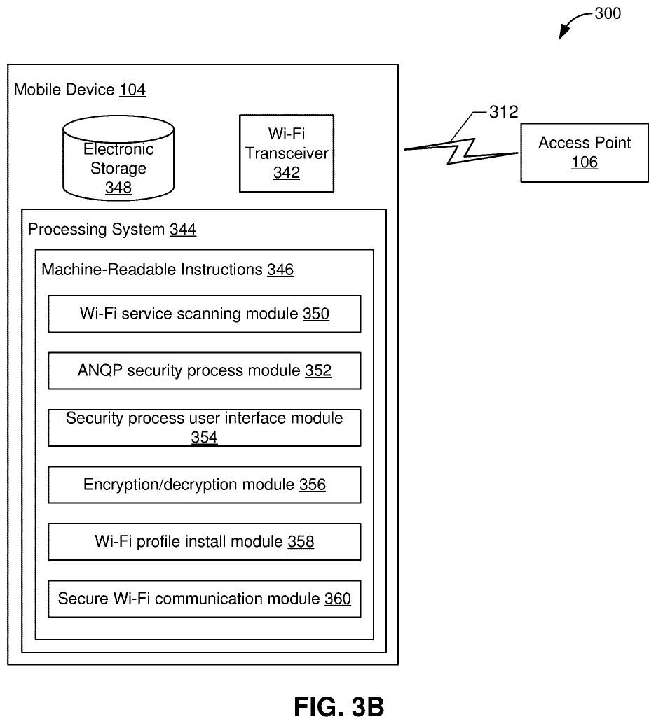

FIG. 3A illustrates a block diagram of a provisioning system 300 for enabling secure Wi-Fi access, focusing on components and functional modules of the access point 106. With reference to FIGS. 1-3A, the provisioning system 300 includes an access point 106 that communicates with a mobile device 104 through a wireless link 312. The provisioning system 300 may also include a network backend 314 that connects to third-party servers 318 through a communication link 316. In some embodiments, the network backend 314 interfaces with the access point 106 to support authentication of the mobile device and/or user, as well as provide other backend services. In such embodiments, the network backend 314 may provide information for creating an account such as terms and conditions (T&C) for user acknowledgment, which may be included in the ANQP response containing provisioning information that is sent by the access point 106.

The access point 106 includes a processing system 304, electronic storage 308, and a Wi-Fi transceiver 310. The processing system 304 may be configured by machine-readable instructions 306, which may be stored in the electronic storage 308. Machine-readable instructions 306 may include one or more instruction modules. The instruction modules may include computer program modules. In some embodiments, the functions of the instruction modules may be implemented in software, firmware, hardware (e.g., circuitry), or a combination of software and hardware, which are configured to perform particular operations or functions. The instruction modules may include a Wi-Fi advertisement module 320, an ANQP security process module 322, a user/device authentication module 324, an encryption/decryption module 326, a Wi-Fi profile generation module 328, and a secure Wi-Fi communication module 330.

In some embodiments, the Wi-Fi advertisement module 320 may configure the processing system 304 to perform the operations for broadcasting beacon frames that advertise support for ANQP and walk-in provisioning capability. The beacon frames may include vendor-specific elements (VSEs) signaling support for the walk-in provisioning capability.

The ANQP security process module 322 may configure the processing system 304 to handle ANQP queries and responses between the access point 106 and the mobile device 104. This may include generating the ANQP response messages including inserting into message packets the requests and information associated with the ANQP and walk-in provisioning capability as described herein. In some embodiments, this module may process login information requests from the mobile device 104, which may include an International Mobile Subscriber Identity (IMSI) or a Network Access Identifier (NAI).

The user/device authentication module 324 may configure the processing system 304 to perform operations for authenticating the mobile device 104 and/or the user 102 based on information provided in ANQP queries as described herein. In some embodiments, this module may use an Extensible Authentication Protocol (EAP) with IMSI for subscriber verification. In embodiments in which mobile device 104 and/or user authentication is performed in the access point 106, the user/device authentication module 324 may configure the processing system 304 to perform the authentication operations. In embodiments in which mobile device 104 and/or user authentication is performed in another service, such as a network backend service or an authentication service coupled to the network backend service, the user/device authentication module 324 may configure the processing system 304 to pass network access requests and encrypted information provided by the mobile device 104 to the authentication service and receive and send on to the mobile device 104 an encrypted Wi-Fi profile to the mobile device 104 as described herein.

The encryption/decryption module 326 may configure the processing system 304 to handle the encryption and decryption of communications between the access point 106 and the mobile device 104. This module may not be implemented in embodiments in which mobile device 104 and/or user authentication is performed in another service as that service may perform the encryption and decryption of communications with the mobile device 104 as described herein. In some embodiments, this module may use Protected Management Frames (PMF) to encrypt all communications, securing the provisioning process.

The Wi-Fi profile generation module 328 may configure the processing system 304 to create encrypted Wi-Fi profiles based on the mobile device's public key and network configuration parameters. This module may not be implemented in embodiments in which mobile device and/or user authentication is performed in another service as described herein.

The secure Wi-Fi communication module 330 may configure the processing system 304 to manage the secure connection established with the mobile device 104 after successful provisioning.

The electronic storage 308 may include non-transitory storage media that electronically stores information. The electronic storage media of electronic storage 308 may include one or both system storage that is provided integrally (i.e., substantially non-removable) and/or removable storage that is removably connectable to the access point 106 (e.g., via a universal serial bus (USB) port, a firewire port, etc.). Electronic storage 408 may include one or more virtual storage resources (e.g., cloud storage, a virtual private network, and/or other virtual storage resources). Electronic storage 308 may store software algorithms, information determined by the processing system 304, information received from the mobile device 104, or other information that enables the walk-in provisioning processes as described herein.

The description of the functionality provided by the different modules 320-330 is for illustrative purposes and is not intended to be limiting, as any of modules 320-330 may provide more or less functionality than is described. For example, one or more of the modules 320-330 may be eliminated, and some or all of a module's functionality may be provided by other modules. As another example, the processing system(s) 404 may be configured to execute one or more additional modules that may perform some or all of the functionality of the modules 320-330.

FIG. 3B illustrates a block diagram of the provisioning system 300 for enabling secure Wi-Fi access, focusing on components and functional modules of the mobile device 104. With reference to FIGS. 1-3B, the mobile device 104 also includes a Wi-Fi transceiver 342, a processing system 344, and an electronic storage 348 for storing data and instructions. The Wi-Fi transceiver 342 supports wireless communication with the access point 106, which enables the exchange of provisioning information, authentication data, and Wi-Fi profiles between the devices as described herein.

The processing system 344 may be configured by machine-readable instructions 346, which may be stored in the electronic storage 348. Machine-readable instructions 346 may include one or more instruction modules. The instruction modules may include computer program modules. In some embodiments, the functions of the instruction modules may be implemented in software, firmware, hardware (e.g., circuitry), or a combination of software and hardware, which are configured to perform particular operations or functions. The instruction modules may include a Wi-Fi service scanning module 350, an ANQP security process module 352, a security process user interface module 354, an encryption/decryption module 356, a Wi-Fi profile install module 358, and a secure Wi-Fi communication module 360, as well as other modules.

The Wi-Fi service scanning module 350 may configure the processing system 344 to perform network scanning operations to detect available Wi-Fi networks. In some embodiments, the Wi-Fi service scanning module 350 may scan for beacon frames broadcasted by the access point 106 that advertise support for ANQP and walk-in provisioning capability.

The ANQP security process module 352 may configure the processing system 344 to handle security protocols related to ANQP communications. The ANQP security process module 352 may process ANQP queries and responses exchanged between the mobile device 104 and the access point 106 as described herein.

The security process user interface module 354 may configure the processing system 344 to manage user interactions during the security process. In some embodiments, the security process user interface module 354 may prompt the user to image credential information, such as scanning a barcode or QR code. This module may display user prompts (e.g., for a username and password) and collect user responses related to network selection and credential input as described herein.

The encryption/decryption module 356 may configure the processing system 344 to handle secure data transmission between the mobile device 104 and the access point 106. In some embodiments, the encryption/decryption module 356 may encrypt the transmitted credentials using a public key of the access point or an authentication service to provide security for the provisioning process. The encryption/decryption module 356 may also secure all communications with the access point 106 using PMF to prevent tampering or interception, as well as secure communications following completion of the provisioning processes.

The Wi-Fi profile install module 358 may configure the processing system 344 to manage the installation of Wi-Fi profiles received from the access point 106. In some embodiments, the Wi-Fi profile install module 358 may decrypt and install encrypted Wi-Fi profiles generated based on the mobile device's public key and network configuration parameters to complete the walk-in provisioning process.

The secure Wi-Fi communication module 360 may configure the processing system 344 to establish and maintain protected connections with the access point 106 after successful provisioning. This module may handle the association process with the network using the installed Wi-Fi profile.

The electronic storage 348 may include non-transitory storage media that electronically stores information. The electronic storage media of electronic storage 348 may include one or both system storage that is provided integrally (i.e., substantially non-removable) and/or removable storage that is removably connectable to the mobile device (e.g., via a USB port, a firewire port, etc.). Electronic storage 348 may include one or more virtual storage resources (e.g., cloud storage, a virtual private network, and/or other virtual storage resources). Electronic storage 348 may store software algorithms, information determined by the processing system) 344, information received from the access point 106, or other information that enables the mobile device to function as described herein.

The description of the functionality provided by the different modules 350-360 is for illustrative purposes, and is not intended to be limiting, as any of modules 350-360 may provide more or less functionality than is described. For example, one or more of the modules 350-360 may be eliminated, and some or all of a module's functionality may be provided by other modules. As another example, the processing system 344 may be configured to execute one or more additional modules that may perform some or all of the functionality of the modules 350-360.

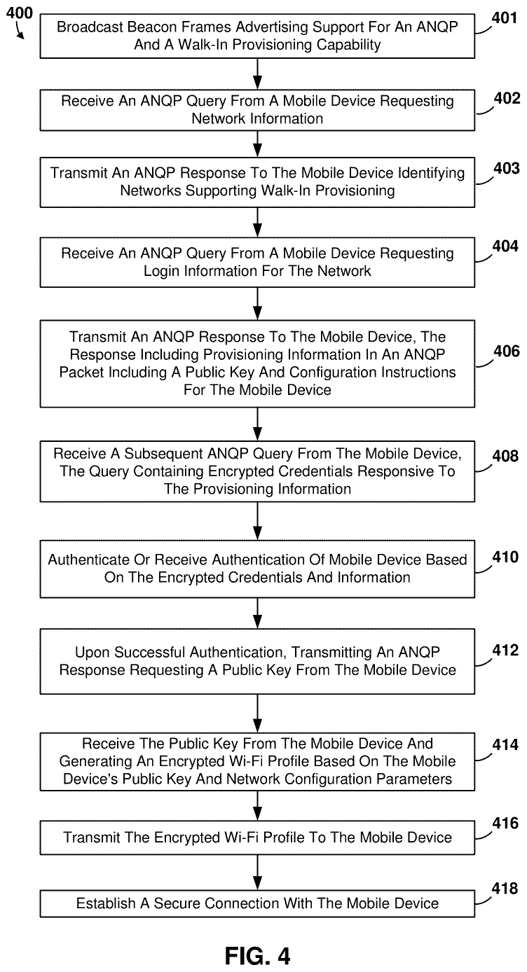

FIG. 4 is a process flow diagram of a method 400 that may be performed by an access point 106 for provisioning a mobile device 104 to access a Wi-Fi network in accordance with some embodiments. With reference to FIGS. 1-4, the method 400 may be performed in a computing device function as an access point 106, such as a Wi-Fi router (e.g., 106), by a processing system (e.g., 304) encompassing one or more components or subsystems discussed in this application. Means for performing the functions of the operations in method 400 may include a processing system including one or more processors and other components described herein. Further, one or more processors of a processing system may be configured with software or firmware modules (e.g., 320-330) to perform some or all of the operations of method 400. To encompass the alternative configurations enabled in various embodiments, the hardware implementing any or all of the method 400 is referred to herein as a “processing system.”

In block 401, the access point 106 broadcasts beacon frames advertising support for the ANQP and a walk-in provisioning capability. In some embodiments, the beacon frames may include vendor-specific elements (VSEs) signaling support for the walk-in provisioning capability. Related Wi-Fi access points do not include the ANQP and walk-in provisioning capability information, so the processing system of the access point may be configured with software and/or firmware to add this functionality as part of implementing various embodiments.

In block 402, the access point 106 processing system may receive an initial (i.e., first) ANQP query from the mobile device requesting network information, such as regarding information regarding networks that support walk-in provisioning.

In block 403, the access point 106 processing system may transmit a first ANQP response to the mobile device providing the requested network information, which may include a listing of all networks connected to the access point that support walk-in provisioning.

In block 404, the access point 106 processing system may receive a second ANQP query from the mobile device requesting login information for the network. This query may also request the network's public key, which will enable the mobile device to encrypt information sent to the network. The login information requested may include an International Mobile Subscriber Identity (IMSI) or a Network Access Identifier (NAI). In some embodiments, an ANQP message packet may include an indication that the request for login information is for accomplishing a secure login using the walk-in provisioning method of various embodiments.

In block 406, the processing system may assemble and transmit a second ANQP response to the mobile device 104. The ANQP response may include information for creating an account and provisioning information in an ANQP packet containing a public key and configuration instructions for the mobile device 104. In some embodiments, the information for creating an account provided in the ANQP response may include terms and conditions for user acknowledgment. In some embodiments, the information for creating an account conveyed in the ANQP response may specify information that the mobile device 104 and/or the user 102 must provide to enable the authentication necessary before accessing the network.

In some embodiments, the access point 106 processing system has the public key and configuration instructions to provide to the mobile device 104 in the ANQP response.

In some embodiments, the access point 106 processing system obtains the public key and configuration instructions from another computing device, such as a network backend service or an authentication service coupled to the network backend service that has the information (e.g., an authorized mobile device and/or user identity database) and functionality to identify and authenticate authorized mobile devices and/or users. As noted above, for ease of reference, the authenticating computing device is referred to herein as a network backend service to encompass any location of the server and database providing the authentication functionality.

In such embodiments, as part of the operations in block 406, the access point may send a request to the network backend service (e.g., communication 120) indicating the network for which access is requested and requesting (or otherwise indicating a need for) a public key and at least some of the login information to be sent back to the mobile device. In response, the network backend service may return the login information (or at least that portion controlled by the backend service), and the access point 106 processing system may include that information and the public key in one or more ANQP response packets that the access point then transmits to the requesting mobile device 104. Such embodiments enable access to be controlled by the network or an authority controlling the network or a service or database accessible via the network, enabling access points to be simple wireless modems or network hubs that are incapable of decrypting subsequent ANPQ queries from the mobile device 104 that include information encrypted using the network backend service provided public key.

In block 408, the access point 106 processing system may receive another (i.e., third) ANQP query from the mobile device 104 that includes within ANQP query packets encrypted information and/or credentials responsive to the provisioning information provided in the ANQP response transmitted in block 406. In embodiments in which the access point 106 has the role, information, and functionality to authenticate the mobile device 104 and/or the user 102 (via the mobile device 104), the access point 106 processing system may decrypt the information and/or credentials within the message packet(s) as part of the operations in block 408. In embodiments in which the network backend system performs mobile device/user authentication, the access point 106 processing system sends the encrypted information and/or credentials extracted from ANQP query packets to the network backend system (e.g., in communication 130).

In block 410, either the access point 106 processing system or the network backend system authenticates the encrypted credentials provided by the mobile device 104. In some embodiments, the access point 106 may send a request to the network backend system to identify the information required from the user 102 and mobile device 104. The network backend system may decrypt and authenticate the information from the mobile device 104. In some embodiments, the access point may pass the encrypted information from the mobile device 104 to the network backend system without decryption.

The authentication process in block 410 involves verifying the encrypted credentials provided by the mobile device 104 to determine whether the mobile device 104 and/or user 102 are authorized to access the Wi-Fi network. The authentication process may be an important element in the methods and protocols used by a network, network operator, or authority over a secure resource (e.g., a database) accessible via the secure network to ensure the security and integrity of the provisioning process.

The access point 106 processing system may handle the authentication process directly or forward the mobile device 104 and/or user information, certificates, etc. to a network backend system to perform the authentication, depending on the network architecture and security policies.

In implementations in which the network backend system handles authentication, the access point 106 processing system may act as an intermediary, forwarding the authentication request and information to the backend systems without decryption. This enhances security by ensuring that sensitive credentials are only decrypted and processed within the most secure parts of the network infrastructure. The authentication process may involve various methods, such as checking username and password combinations, verifying digital certificates, or validating tokens. Advanced authentication mechanisms may include multi-factor authentication or biometric verification, depending on the network's security requirements and the capabilities of the mobile device 104.

In instances in which authentication fails, the access point 106 processing system or the network backend system may deny access or request additional information from the user 102, ensuring that only authorized devices can proceed with the Wi-Fi network provisioning process.

Upon successful authentication, the access point 106 may transmit a third ANQP response requesting a public key from the mobile device 104 in block 412.

In block 414, the access point 106 processing system may receive the public key from the mobile device 104 in a fourth ANQP query message. In embodiments in which the access device 106 authenticates the mobile device 104 and/or user 102, the access point 106 may generate an encrypted Wi-Fi profile based on network configuration parameters using the mobile device's public key. In embodiments in which the network backend system authenticates the mobile device 104 and/or user 102, the network backend system may provide the encrypted Wi-Fi profile of provisioning information (encrypted using the mobile device's public key) to the access point 106 for sending to the mobile device 104.

In block 416, the access point 106 processing system transmits the encrypted Wi-Fi profile to the mobile device 104 in a fourth ANQP response message. This profile may include all necessary elements for network association, such as network configuration details, authentication methods, and credentials.

In block 418, the processing system may perform operations to establish a secure connection between the access point 106 and the mobile device 104. This may involve completing any remaining authentication operations and exchanging handshaking messages to ensure that the mobile device 104 is fully provisioned and authenticated for secure data exchanges on the network.

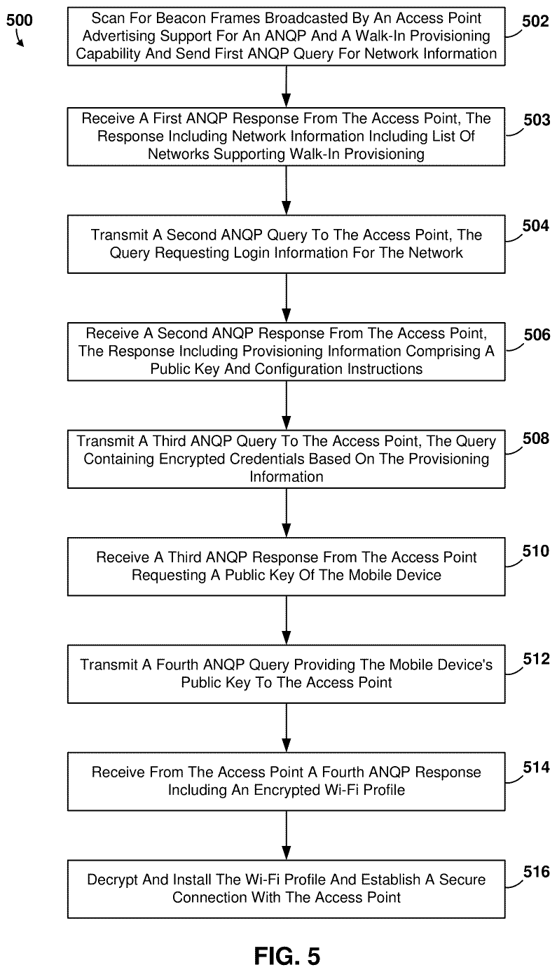

FIG. 5 is a process flow diagram of a method 500 that may be performed by a mobile device 104 for communicating with an access point 106 to provision the mobile device to access a Wi-Fi network in accordance with some embodiments. With reference to FIGS. 1-5, the method 500 may be performed in a mobile device (e.g., 104), by a processing system (e.g., 344) encompassing one or more components or subsystems discussed in this application. Means for performing the functions of the operations in method 500 may include a processing system including one or more processors and other components described herein. Further, one or more processors of a processing system may be configured with software or firmware modules (e.g., 350-360) to perform some or all of the operations of the method 500. To encompass the alternative configurations enabled in various embodiments, the hardware implementing any or all of the method 500 is referred to herein as a “processing system.”

In block 502, the mobile device 104 scans for beacon frames broadcasted by the access point 106. These beacon frames may advertise support for the ANQP and walk-in provisioning capability. Related Wi-Fi-capable mobile devices do not include functionality to look for the ANQP and walk-in provisioning capability information, so the mobile device processing system may be configured with software and/or firmware to add this functionality as part of implementing various embodiments. As part of the operations in block 502, if the access point 106 supports walk-in provisioning, the mobile device 104 processing system may generate and transmit a first ANQP query message to the access point 106 in which one or more ANQP message packets includes a request for network information, which may include a request for networks supporting walk-in provisioning.

In block 503, the mobile device 104 processing system may receive a first ANQP response message from the access point 106 in which one or more ANQP message packets includes network information, which may include a list of networks supporting walk-in provisioning.

In block 504, the mobile device 104 processing system generates and transmits a second ANQP query message to the access point 106 in which one or more ANQP message packets includes a request for login information for a network that supports walk-in provisioning. In some embodiments the one or more ANQP message packets may include an indication that the login information is for accomplishing a secure login using the walk-in provisioning method of various embodiments. In some embodiments, the login information requested may include an IMSI or a NAI. In some embodiments, the second ANQP query message may include a request for a public key of the network (or the access point) that the mobile device can use to encrypt information send to the network in subsequent ANQP query messages.

In block 506, the mobile device 104 may receive a second ANQP response message 124 from the access point 106. The second ANQP response message 124 may contain provisioning information including a public key and configuration instructions. In some embodiments, the provisioning information may include specific information about the user 102 and/or the mobile device 104 that is required for authentication and accessing the network.

In block 508, the mobile device 104 transmits a third ANQP query message 128 to the access point 106. The third ANQP query message 128 may contain encrypted credentials based on the received provisioning information. In some embodiments, the mobile device 104 may encrypt the transmitted credentials using public key infrastructure (PKI) for enhanced security.

In block 510, the mobile device 104 may receive a third ANQP response 136 from the access point 106. The third ANQP response 136 may request the mobile device's public key. Obtaining the mobile device's public key enables the access point or the network backend service to encrypt the Wi-Fi profile provisioning information so only the mobile device and receive and use the information.

In block 512, the mobile device 104 may transmit a fourth ANQP query message to the access point providing the mobile device's public key.

In block 514, the mobile device 104 receives from the access point 106 a fourth ANQP response that includes an encrypted Wi-Fi profile providing the configuration and provisioning information needed by the mobile device 104 to establish a secure link to the requested network via the access point 106. In some embodiments, the Wi-Fi profile of provisioning information may be in XML format describing the network's Passpoint configuration, domain name, and authentication realms.

In block 516, the mobile device 104 decrypts and installs the Wi-Fi profile, and then establishes a secure connection with the access point 106. In some embodiments, the mobile device may use Protected Management Frames (PMF) and encryption to secure all communication with the access point 106, preventing tampering or interception during the provisioning process.

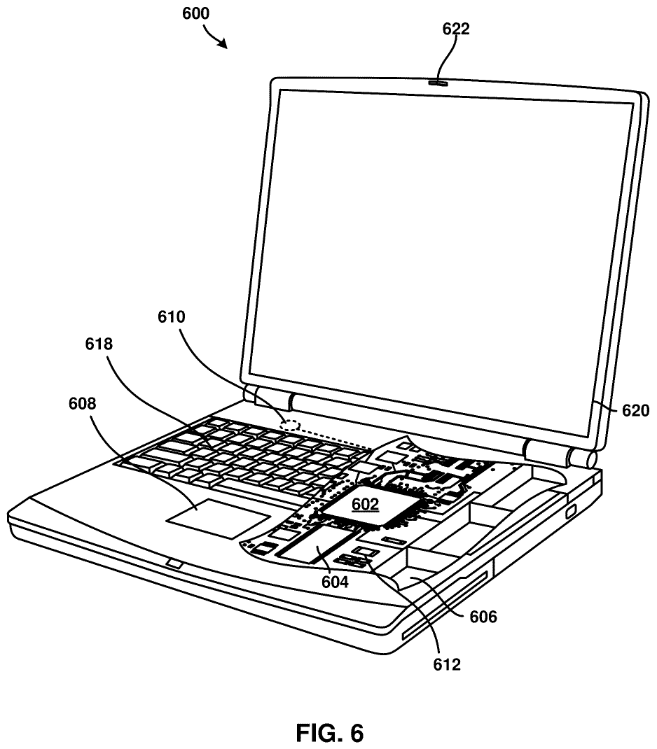

FIG. 6 illustrates a perspective view of a mobile computing device 600 suitable for implementing various embodiments. The mobile computing device 600 may include a processing system 602 and a memory module 604. The processing system 602 may execute instructions stored in the memory module 604 to perform various functions related to Wi-Fi provisioning, such as scanning for networks, processing ANQP queries and responses, and installing Wi-Fi profiles as described herein.

A Wi-Fi transceiver 606 may be integrated into the mobile computing device 600 for wireless communication capabilities. The Wi-Fi transceiver 606 may be responsible for transmitting and receiving Wi-Fi signals, including the ANQP query messages and ANQP response messages in the provisioning process as described. A Wi-Fi antenna 610 may be incorporated into the mobile computing device 600 for wireless signal transmission and reception. The Wi-Fi antenna 610 may be coupled to the Wi-Fi transceiver 606 to support communication with access points during the provisioning process.

The mobile computing device 600 may feature a keyboard 618 for user input. The keyboard 618 may be used to enter credentials or other information required during the provisioning process, such as responding to user prompts displayed on the mobile computing device 600 The mobile computing device may also include a touchpad 608, which may provide an additional for user interface useful during the provisioning process, such as for selecting networks or confirming actions.

A communication interface 612 may be provided for external connectivity. In some embodiments, the communication interface 612 may be used for wired connections or alternative wireless protocols that may supplement the Wi-Fi provisioning process.

The mobile computing device 600 may include a display screen 620 that can be adjusted to different viewing angles. The display screen 620 may be used to present user prompts, display lists of available networks, and show other information related to the Wi-Fi provisioning process.

A camera module 622 may be positioned at the top of the display screen 620. In some embodiments, the camera module 622 may be used for capturing images of credentials or QR codes that contain provisioning information useful for some provisioning methods as described.

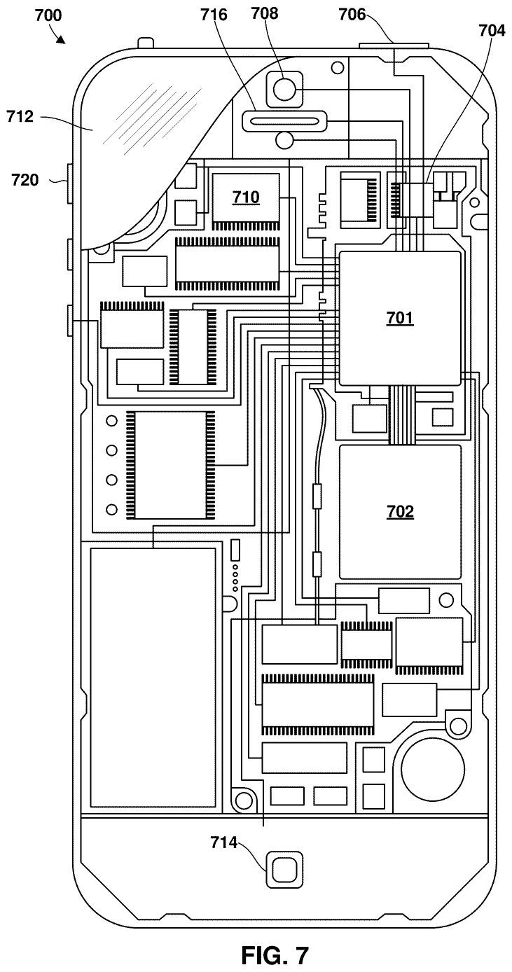

FIG. 7 illustrates a section view of a mobile device 700 suitable for implementing various embodiments. The mobile device 700 may include several components that enable Wi-Fi provisioning capabilities as described in the methods above.

The mobile device 700 includes a processor 701 and a memory module 702. The processor 701 may execute processor-executable instructions stored in the memory module 702 to perform various functions related to Wi-Fi provisioning, including processing ANQP queries and responses, and installing Wi-Fi profiles as described herein. The mobile device 700 may further include a modem module 710.

A Wi-Fi transceiver 704 may be connected to an antenna 706 located in the mobile device 700. The Wi-Fi transceiver 704 and antenna 706 may be responsible for transmitting and receiving Wi-Fi signals, including the ANQP query messages and ANQP response messages described in the provisioning process.

A camera 708 may be positioned in the upper portion of the mobile device 700. In some embodiments, the camera 708 may be used for capturing images of credentials or QR codes that contain provisioning information in some provisioning methods as described above.

The mobile device 700 may include an inertial measurement unit (IMU) 710 configured to provide motion sensing capabilities that may be utilized in certain authentication or user interaction scenarios during the provisioning process.

The mobile device 700 may include a display screen 712 on the front surface. The display screen 712 may be used to present user prompts, display lists of available networks, and show other information related to the Wi-Fi provisioning process.

A microphone 714 may be located on the mobile device 700. In some embodiments, the microphone 714 may be used for voice commands or audio-based authentication during the provisioning process.

The mobile device 700 may include a speaker 716, which may provide audio feedback or instructions to the user during the Wi-Fi provisioning process.

An input button 720 may be located along a side of the mobile device 700. The input button 720 may provide an additional means for user interaction during the provisioning process, such as confirming actions or initiating network scans.

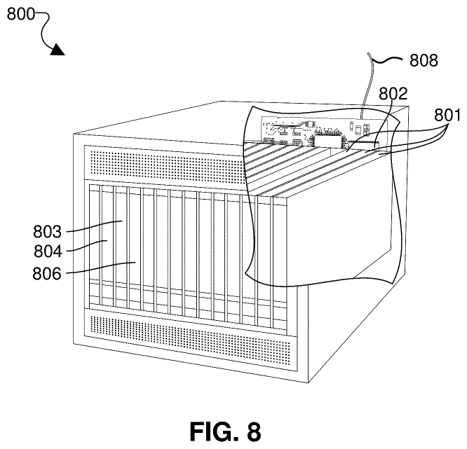

FIG. 8 illustrates a perspective view of a server 800 suitable for implementing various embodiments, such as in an access point or a network backend service. The server 800 may include a processing system 801 and memory 802. The processing system 801 may execute instructions stored in the memory 802 to perform various functions related to Wi-Fi provisioning, such as processing authentication requests and generating Wi-Fi profiles.

A storage module 803 may include multiple storage slots 804 to accommodate storage devices that store user credentials, network configuration parameters, and other data necessary for the Wi-Fi provisioning process.

The server 800 may also include a network interface 806 that connects to a network connection 808, enabling communication with other devices such as the access point and third party servers. In some embodiments, the network interface 806 may facilitate the exchange of ANQP query messages and ANQP response messages between the server 800 and the access point during the provisioning process.

In some embodiments, the server 800 may function as part of the network backend system or as another authentication service in the Wi-Fi provisioning process. The server 800 may process authentication requests, generate Wi-Fi profiles, and manage user credentials, playing a crucial role in the secure provisioning of mobile devices to Wi-Fi networks.

Implementation examples are described in the following paragraphs. While some of the following implementation examples are described in terms of example methods, further example implementations may include: the example methods discussed in the following paragraphs implemented by a computing system including a processing system configured (e.g., with processor-executable instructions) to perform operations of the methods of the following implementation examples; and the example methods discussed in the following paragraphs may be implemented as a non-transitory processor-readable storage medium having stored thereon processor-executable instructions configured to cause a processing system of a computing system to perform the operations of the methods of the following implementation examples.

Example 1. A method for provisioning a mobile device to access a Wi-Fi network via an access point, including: broadcasting, by the access point, beacon frames advertising support for an Access Network Query Protocol (ANQP) and a walk-in provisioning capability; receiving, by the access point, an ANQP query from the mobile device requesting network information; transmitting, by the access point, an ANQP response to the mobile device, the ANQP response including network information in an ANQP packet including a listing of Wi-Fi networks supporting walk-in provisioning; receiving, by the access point, an ANQP query from the mobile device requesting login information for a Wi-Fi network supporting walk-in provisioning; transmitting, by the access point, an ANQP response to the mobile device, the ANQP response including provisioning information for the requested Wi-Fi network in an ANQP packet including a public key and configuration instructions for the mobile device; receiving, by the access point, a subsequent ANQP query from the mobile device, the query containing encrypted credentials responsive to the provisioning information; authenticating, by the access point or a network backend system, the encrypted credentials provided by the mobile device; upon successful authentication, transmitting, by the access point, an ANQP response requesting a public key from the mobile device; receiving, by the AP, the public key from the mobile device and generating or receiving from the network backend system an encrypted Wi-Fi profile based on the mobile device's public key and network configuration parameters; transmitting, by the AP, the encrypted Wi-Fi profile to the mobile device; and establishing a secure connection with the mobile device.

Example 2. The method of example 1, in which the beacon frames further include vendor-specific elements (VSEs) signaling support for the walk-in provisioning capability.

Example 3. The method of either of examples 1 or 2, in which the login information requested by the mobile device includes an International Mobile Subscriber Identity (IMSI) or a Network Access Identifier (NAI).

Example 4. The method of any of examples 1-3, in which the ANQP response containing provisioning information further includes information for creating an account such as terms and conditions for user acknowledgment.

Example 5. The method of any of examples 1-4, in which the authenticating operation uses Extensible Authentication Protocol (EAP) with IMSI for subscriber verification.

Example 6. The method of any of examples 1-5, further including encrypting all communications between the mobile device and the access point using Protected Management Frames (PMF) to secure the method for provisioning the mobile device.

Example 7. A method for provisioning a mobile device to access a Wi-Fi network, including: scanning, by the mobile device, for beacon frames broadcasted by an access point, the beacon frames advertising support for an Access Network Query Protocol (ANQP) and a walk-in provisioning capability; transmitting, by the mobile device, a first ANQP query to the access point, the query requesting network information for Wi-Fi networks supporting walk-in provisioning; receiving, by the mobile device, a first ANQP response from the access point, the response including network information for networks supporting walk-in provisioning; transmitting, by the mobile device, a second ANQP query to the access point, the query requesting login information for the network; receiving, by the mobile device, a second ANQP response from the access point, the response including provisioning information including a public key and configuration instructions; transmitting, by the mobile device, a third ANQP query to the access point, the query containing encrypted credentials and information responsive to the provisioning information; receiving, by the mobile device, a third ANQP response from the access point requesting a public key of the mobile device; transmitting, by the mobile device, the mobile device's public key to the access point in a fourth ANQP query; receiving, by the mobile device, a fourth ANQP response including an encrypted Wi-Fi profile from the access point, the profile generated based on the public key and network configuration parameters; and decrypting and installing, by the mobile device, the encrypted Wi-Fi profile to establish a secure connection with the access point.

Example 8. The method of example 7, in which the mobile device displays a graphical user interface (GUI) listing available networks supporting walk-in provisioning and allowing a user to select a network to join.

Example 9. The method of either of examples 7 or 8, in which the login information requested by the mobile device includes an International Mobile Subscriber Identity (IMSI) or a Network Access Identifier (NAI).

Example 10. The method of any of examples 7-9, in which the provisioning information received in the second ANQP response further includes information for creating an account such as terms and conditions for user acknowledgment.

Example 11. The method of any of examples 7-10, in which the mobile device encrypts the transmitted credentials using a public key received from the access point.

Example 12. The method of any of examples 7-12, further including securing all communication between the mobile device and the access point using Protected Management Frames (PMF) and encryption.

As used in this application, terminology such as “unit,” “component,” “module,” “system,” etc., is intended to encompass a software-implemented or computer-related entity. These entities may involve, among other possibilities, hardware, firmware, a blend of hardware and software, software alone, or software in an operational state. As examples, a component may encompass a running process on a processor, the processing system itself, an object, an executable file, a thread of execution, a program, or a computing device. To illustrate further, both an application operating on a computing device and the computing device itself may be designated as a component. A component might be situated within a single process or thread of execution or could be distributed across multiple processors or cores. In addition, these components may operate based on various non-volatile computer-readable media that store diverse instructions and/or data structures. Communication between components may take place through local or remote processes, function or procedure calls, electronic signaling, data packet exchanges, and memory interactions, among other known methods of network, computer, processor, or process-related communications.

A number of different types of memories and memory technologies are available or contemplated in the future, any or all of which may be included and used in systems and computing devices that implement the various embodiments.

Various embodiments illustrated and described are provided merely as examples to illustrate various features of the claims. However, features shown and described with respect to any given embodiment are not necessarily limited to the associated embodiment and may be used or combined with other embodiments that are shown and described. Further, the claims are not intended to be limited by any one example embodiment. For example, one or more of the operations of the methods may be substituted for or combined with one or more operations of the methods.

The foregoing method descriptions and the process flow diagrams are provided merely as illustrative examples and are not intended to require or imply that the operations of various embodiments must be performed in the order presented. As will be appreciated by one of skill in the art the order of operations in the foregoing embodiments may be performed in any order. Words such as “thereafter,” “then,” “next,” etc. are not intended to limit the order of the operations; these words are simply used to guide the reader through the description of the methods. Further, any reference to claim elements in the singular, for example, using the articles “a,” “an,” or “the” is not to be construed as limiting the element to the singular.

The various illustrative logical blocks, modules, circuits, and algorithm operations described in connection with the embodiments disclosed herein may be implemented as electronic hardware, computer software, or combinations of both. To clearly illustrate this interchangeability of hardware and software, various illustrative components, blocks, modules, circuits, and operations have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the claims.

In one or more embodiments, the functions described may be implemented in hardware, software, firmware, or any combination thereof. If implemented in software, the functions may be stored as one or more instructions or code on a non-transitory computer-readable medium or non-transitory processor-readable medium. The operations of a method or algorithm disclosed herein may be embodied in a processor-executable software module, which may reside on a non-transitory computer-readable or processor-readable storage medium. Non-transitory computer-readable or processor-readable storage media may be any storage media that may be accessed by a computer or a processor. By way of example but not limitation, such non-transitory computer-readable or processor-readable media may include random access memory (RAM), read-only memory (ROM), electrically erasable programmable read-only memory (EEPROM), FLASH memory, solid-state drives (SSD), non-volatile memory express (NVMe) drives, or any other medium that may be used to store target program code in the form of instructions or data structures and that may be accessed by a computer. Modern technologies, such as cloud-based storage solutions, including infrastructure-as-a-service (IaaS) platforms, may offer scalable and distributed options for storing and accessing program code.

In addition, the operations of a method or algorithm may reside as one or any combination or set of codes and/or instructions on a non-transitory processor-readable medium and/or computer-readable medium, which may be incorporated into a computer program product. Emerging technologies, including quantum computing storage media and blockchain-based storage solutions, may further enhance data integrity and security. Artificial intelligence (AI) and machine learning (ML)-optimized hardware accelerators, such as graphical processing systems (GPUs) and tensor processing systems (TPUs), may be used to execute complex algorithms.

The preceding description of the disclosed embodiments is provided to enable any person skilled in the art to make or use the claims. Various modifications to these embodiments will be readily apparent to those skilled in the art, and the generic principles defined herein may be applied to other embodiments without departing from the scope of the claims. Thus, the present disclosure is not intended to be limited to the embodiments shown herein but is to be accorded the widest scope consistent with the following claims and the principles and novel features disclosed herein.

We claim:

1. A method for provisioning a mobile device to access a Wi-Fi network via an access point, comprising:
using Access Network Query Protocol (ANQP) messages to transmit provision information for accessing the Wi-Fi network to the mobile device.

2. The method of claim 1, wherein using ANQP messages to transmit provision information to the mobile device comprises:
broadcasting, by the access point, beacon frames advertising support for ANQP and a walk-in provisioning capability;
receiving, by the access point, an ANQP query from the mobile device requesting network information;
transmitting, by the access point, an ANQP response to the mobile device, the ANQP response including network information in an ANQP packet including a listing of Wi-Fi networks supporting walk-in provisioning;
receiving, by the access point, an ANQP query from the mobile device requesting login information for a Wi-Fi network supporting walk-in provisioning;
transmitting, by the access point, an ANQP response to the mobile device, the ANQP response including provisioning information for the requested Wi-Fi network in an ANQP packet including a public key and configuration instructions for the mobile device;
receiving, by the access point, a subsequent ANQP query from the mobile device, the query containing encrypted credentials responsive to the provisioning information;
authenticating, by the access point or a network backend system, the encrypted credentials provided by the mobile device;
upon successful authentication, transmitting, by the access point, an ANQP response requesting a public key from the mobile device;
receiving, by the access point, the public key from the mobile device in an ANQP query and generating or receiving from the network backend system an encrypted Wi-Fi profile based on the mobile device's public key and network configuration parameters; and
transmitting, by the access point, the encrypted Wi-Fi profile to the mobile device in an ANQP response for use in establishing a secure connection between the mobile device and the access point.

3. The method of claim 2, wherein the beacon frames further include vendor-specific elements (VSEs) signaling support for the walk-in provisioning capability.

4. The method of claim 2, wherein the login information requested by the mobile device includes an International Mobile Subscriber Identity (IMSI) or a Network Access Identifier (NAI).

5. The method of claim 2, wherein the ANQP response containing provisioning information further includes terms and conditions for user acknowledgment.

6. The method of claim 2, wherein the authenticating operation uses Extensible Authentication Protocol (EAP) with IMSI for subscriber verification.

7. The method of claim 2, further comprising encrypting all communications between the mobile device and the access point using Protected Management Frames (PMF) to secure the method for provisioning the mobile device.

8. A method for provisioning a mobile device to access a Wi-Fi network, comprising:
using Access Network Query Protocol (ANQP) messages to request and receive provision information for the Wi-Fi network from an access point.

9. The method of claim 8, wherein using ANQP messages to request and receive provision information for the Wi-Fi network from the access point comprises:
scanning, by the mobile device, for beacon frames broadcasted by the access point that advertise support for ANQP provisioning and a walk-in provisioning capability;
transmitting, by the mobile device, a first ANQP query to the access point, the query requesting network information for Wi-Fi networks supporting walk-in provisioning;
receiving, by the mobile device, a first ANQP response from the access point, the response including network information for networks supporting walk-in provisioning;
transmitting, by the mobile device, a second ANQP query to the access point, the query requesting login information for the network;
receiving, by the mobile device, a second ANQP response from the access point, the response including provisioning information comprising a public key and configuration instructions;
transmitting, by the mobile device, a third ANQP query to the access point, the query containing encrypted credentials and information responsive to the provisioning information;
receiving, by the mobile device, a third ANQP response from the access point requesting a public key of the mobile device;
transmitting, by the mobile device, the mobile device's public key to the access point in a fourth ANQP query;
receiving, by the mobile device, a fourth ANQP response including an encrypted Wi-Fi profile from the access point, the profile generated based on the public key and network configuration parameters; and
decrypting and installing, by the mobile device, the encrypted Wi-Fi profile to establish a secure connection with the access point.

10. The method of claim 9, wherein the mobile device displays a graphical user interface (GUI) listing available networks supporting walk-in provisioning and allowing a user to select a network to join.

11. The method of claim 9, wherein the login information requested by the mobile device includes an International Mobile Subscriber Identity (IMSI) or a Network Access Identifier (NAI).

12. The method of claim 9, wherein the provisioning information received in the second ANQP response further includes terms and conditions for user acknowledgment.

13. The method of claim 9, wherein the mobile device encrypts the transmitted credentials using a public key received from the access point.

14. The method of claim 9, further comprising securing all communication between the mobile device and the access point using Protected Management Frames (PMF) and encryption.

15. A computing device configured as a wireless network access point, comprising:
a Wi-Fi transceiver;
a memory; and
a processing system coupled to the wireless transceiver and memory, and configured with processor-executable instructions to perform operations including using Access Network Query Protocol (ANQP) messages to transmit provision information for accessing a Wi-Fi network to a mobile device.

16. The computing device of claim 15, wherein the processing system is further configured with processor-executable instructions such that using ANQP messages to transmit provision information to the mobile device comprises:
broadcasting beacon frames advertising support for ANQP and a walk-in provisioning capability;
receiving an ANQP query from a mobile device requesting network information;
transmitting an ANQP response to the mobile device, the ANQP response including network information in an ANQP packet including a listing of Wi-Fi networks supporting walk-in provisioning;
receiving an ANQP query from the mobile device requesting login information for a Wi-Fi network supporting walk-in provisioning;
transmitting an ANQP response to the mobile device, the ANQP response including provisioning information for the requested Wi-Fi network in an ANQP packet including a public key and configuration instructions for the mobile device;
receiving a subsequent ANQP query from the mobile device, the query containing encrypted credentials responsive to the provisioning information;
authenticating, by the access point or a network backend system, the encrypted credentials provided by the mobile device;
upon successful authentication, transmitting an ANQP response requesting a public key from the mobile device;
receiving the public key from the mobile device in an ANQP query and generating or receiving from the network backend system an encrypted Wi-Fi profile based on the mobile device's public key and network configuration parameters; and
transmitting the encrypted Wi-Fi profile to the mobile device in an ANQP response for use in establishing a secure connection between the mobile device.

17. The computing device of claim 16, wherein the processing system is further configured with processor-executable instructions such that the beacon frames further include vendor-specific elements (VSEs) signaling support for the walk-in provisioning capability.

18. The computing device of claim 16, wherein the processing system is further configured with processor-executable instructions such that the login information requested by the mobile device includes an International Mobile Subscriber Identity (IMSI) or a Network Access Identifier (NAI).

19. The computing device of claim 16, wherein the processing system is further configured with processor-executable instructions such that the ANQP response containing provisioning information further includes terms and conditions for user acknowledgment.

20. The computing device of claim 16, wherein the processing system is further configured with processor-executable instructions such that the authenticating operation uses Extensible Authentication Protocol (EAP) with IMSI for subscriber verification.

21. The computing device of claim 16, wherein the processing system is configured with processor-executable instructions to perform operations further comprising encrypting all communications between the mobile device and the access point using Protected Management Frames (PMF) to secure the method for provisioning the mobile device.

22. A mobile device, comprising:
a Wi-Fi transceiver;
a memory; and
a processing system coupled to the wireless transceiver and memory, and configured with processor-executable instructions to perform operations including using Access Network Query Protocol (ANQP) messages to request and receive provision information for the Wi-Fi network from an access point.

23. The mobile device of claim 22, wherein the processing system is configured with processor-executable instructions to perform operations such that using Access Network Query Protocol (ANQP) messages to request and receive provision information for the Wi-Fi network from an access point comprises:
scanning for beacon frames broadcasted by an access point, the beacon frames advertising support for ANQP and a walk-in provisioning capability;
transmitting a first ANQP query to the access point, the query requesting network information for Wi-Fi networks supporting walk-in provisioning;
receiving a first ANQP response from the access point, the response including network information for networks supporting walk-in provisioning;
transmitting a second ANQP query to the access point, the query requesting login information for the network;
receiving a second ANQP response from the access point, the response including provisioning information comprising a public key and configuration instructions;
transmitting a third ANQP query to the access point, the query containing encrypted credentials and information responsive to the provisioning information;
receiving a third ANQP response from the access point requesting a public key of the mobile device;
transmitting the mobile device's public key to the access point in a fourth ANQP query;
receiving a fourth ANQP response including an encrypted Wi-Fi profile from the access point, the profile generated based on the public key and network configuration parameters; and
decrypting and installing the encrypted Wi-Fi profile to establish a secure connection with the access point.

24. The mobile device of claim 23, wherein the mobile device displays a graphical user interface (GUI) listing available networks supporting walk-in provisioning and allowing a user to select a network to join.

25. The mobile device of claim 23, wherein the login information requested by the mobile device includes an International Mobile Subscriber Identity (IMSI) or a Network Access Identifier (NAI).

26. The mobile device of claim 23, wherein the provisioning information received in the second ANQP response further includes terms and conditions for user acknowledgment.

27. The mobile device of claim 23, wherein the mobile device encrypts the transmitted credentials using a public key received from the access point.

28. The mobile device of claim 23, further comprising securing all communication between the mobile device and the access point using Protected Management Frames (PMF) and encryption.
